(19) United States
(12) Patent Application Publication
(10) Pub. No.: US 2025/0348120 A1
(43) Pub. Date: Nov. 13, 2025

(54) ON-CHIP VOLTAGE REGULATION WITH DYNAMIC SHUNT CURRENT CONTROL

(71) Applicant: International Business Machines Corporation, Armonk, NY (US)

(72) Inventors: Jens DACI, Poughkeepsie, NY (US); Michael SPERLING, Poughkeepsie, NY (US); Ryan THORPE, New York, NY (US)

(21) Appl. No.: 18/658,600

(22) Filed: May 8, 2024

(51) Int. Cl. G06F 1/26; H02M 3/156

(52) U.S. Cl. CPC G06F 1/26; H02M 3/156

(57) ABSTRACT

Embodiments herein describe circuitry and techniques to implement shunt current control of an on-chip voltage regulator of a memory storage system using hardware components and computer software tools. Disclosed embodiments provide an on-chip voltage regulator with enhanced performance, reducing power requirements, and minimizing noise and voltage fluctuations of the regulator output, based on a cache activity signal produced by a cache controller.

### BACKGROUND

The present invention relates to the field of integrated circuits, and more specifically, to methods for implementing on-chip voltage regulation with dynamic load ranges and on-chip voltage regulators for memory storage systems.

High performance integrated circuits, such as microprocessors and memory storage systems, typically use integrated on-chip voltage regulators. On-chip voltage regulation of loads that have large dynamic load ranges, (e.g., a load range from near-zero load current to high load current) such as cache power rails, remains challenging, particularly, with a two stage feedback system often used for high performance integrated circuits (ICs). In existing two stage feedback voltage regulators, when the load current approaches zero, there is current leakage out of the voltage regulator, which causes the regulator output voltage to overshoot and severely limits the transient response when high load current activity starts again. New techniques, systems, and circuitry for implementing on-chip voltage regulators are needed, for example, to reduce power requirements and effectively and efficiently maintain regulator performance, minimizing noise and voltage fluctuations of the regulator output voltage.

### SUMMARY

According to one embodiment of the present disclosure, a non-limiting method comprises outputting, using a voltage regulator, a regulated output cache voltage to a cache via a cache power rail; producing, by a cache controller, a cache activity signal, based on the cache being accessed; and controlling, using the cache activity signal, a shunt current circuit coupled between the cache power rail and a ground potential to selectively shunt current from the voltage regulator.

According to one embodiment of the present disclosure, a memory storage system comprises a cache, a cache controller coupled to the cache configured to provide a cache activity signal when the cache is being accessed, and a voltage regulator, the voltage regulator configured to output a regulated cache output voltage to the cache via a cache power rail, and the voltage regulator comprises a shunt current circuit coupled between the cache power rail and a ground potential, and configured to selectively provide a shunt current based on the cache activity signal.

According to one embodiment of the present disclosure, a non-limiting on-chip voltage regulator comprises a cache power rail configured to output a regulated cache output voltage to a cache; a shunt current circuit configured to receive the cache output voltage and provide a shunt current; wherein the shunt current circuit comprises a switch coupled between the cache power rail and a shunt resistor coupled to ground; and wherein the switch is configured to receive a control input of a cache activity signal that represents the cache being accessed, wherein the cache activity signal turns off the switch to remove the shunt current from the on-chip voltage regulator when the cache is being accessed.

### BRIEF DESCRIPTION OF THE DRAWINGS

FIG. 1 is a block diagram of an example computer environment for use in conjunction with one or more disclosed embodiments;

FIG. 2 is a block diagram of an example system for implementing shunt current control functions of an on-chip voltage regulator of one or more embodiments of the present disclosure;

FIG. 3 is a schematic and block diagram illustrating further example details of an example an on-chip voltage regulator of FIG. 2 of one or more embodiments of the present disclosure;

FIG. 4 is a chart providing example illustrative waveforms of the system of FIG. 2 of one or more disclosed embodiments; and

FIG. 5 is a flowchart illustrating example features and operations of a method for implementing shunt current control functions of an on-chip voltage regulator of a disclosed embodiment.

### DETAILED DESCRIPTION

Embodiments herein describe circuitry and techniques to implement shunt current control of an on-chip voltage regulator of a memory storage system using hardware components and computer software tools. Disclosed embodiments provide an on-chip voltage regulator with enhanced performance, reducing power requirements, and minimizing noise and voltage fluctuations of the regulator output, based on a cache activity signal produced by a cache controller.

According to an aspect of disclosed embodiments, a non-limiting method is provided. The computer-implemented method comprises outputting, using a voltage regulator, a regulated output cache voltage to a cache via a cache power rail; producing, by a cache controller, a cache activity signal, based on the cache being accessed; and controlling, using the cache activity signal, a shunt current circuit coupled between the cache power rail and a ground potential to selectively shunt current from the voltage regulator. The method enables effective and efficient on-chip voltage regulation, providing substantially constant load to the on-chip voltage regulator independent of cache activity that results in less power supply noise, and reducing on-chip power usage during cache accesses.

According to an aspect of disclosed embodiments, a non-limiting memory storage system is provided. The a memory storage system comprises a cache, a cache controller coupled to the cache configured to provide a cache activity signal when the cache is being accessed, and a voltage regulator, the voltage regulator configured to output a regulated cache output voltage to the cache via a cache power rail, and the voltage regulator comprises a shunt current circuit coupled between the cache power rail and a ground potential, and configured to selectively provide a shunt current based on the cache activity signal. The system enables effective and efficient on-chip voltage regulation, providing substantially constant load to the on-chip voltage regulator independent of cache activity that results in less power supply noise, and reducing on-chip power usage during cache accesses.

According to an aspect of disclosed embodiments, a non-limiting on-chip voltage regulator is provided. The on-chip voltage regulator comprises a cache power rail configured to output a regulated cache output voltage to a cache, a shunt current circuit configured to receive the cache output voltage and provide a shunt current; wherein the shunt current circuit comprises a switch coupled between the cache power rail and a shunt resistor coupled to ground; and wherein the switch is configured to receive a control input of a cache activity signal that represents the cache being accessed, wherein the cache activity signal turns off the switch to remove the shunt current from the on-chip voltage regulator when the cache is being accessed. The on-chip voltage regulator enables effective and efficient on-chip voltage regulation, providing substantially constant load to the on-chip voltage regulator independent of cache activity that results in less power supply noise, and reducing on-chip power usage during cache accesses.

An embodiment of the present disclosure where the shunt current circuit comprises a transistor switch coupled between the cache power rail and a shunt resistor coupled to ground potential, and where the transistor switch receives the cache activity signal at its control input to turn off the transistor switch and remove the shunt current from the voltage regulator when the cache is being accessed. This embodiment enables effective and efficient on-chip voltage regulation, and reducing on-chip power usage during cache accesses.

An embodiment of the present disclosure further includes resetting the cache activity signal, by the cache controller, following the cache being accessed, wherein the shunt current circuit provides shunt current from the voltage regulator based on resetting the cache activity signal. This embodiment enables effective and efficient on-chip voltage regulation, and provides substantially constant load to the on-chip voltage regulator independent of cache activity.

Additionally, an embodiment of the present disclosure where the voltage regulator includes a two-stage on-chip regulator having a first regulator stage receiving a reference voltage at a first input, and the regulated output cache voltage at a second feedback input, and providing its output coupled to a second regulator stage, the second regulator stage receiving the regulated output cache voltage and providing a gate control signal at its output. This embodiment enables effective and efficient on-chip voltage regulation,

Additionally, an embodiment of the present disclosure where the two-stage on-chip regulator includes an output transistor receiving the gate control signal coupled to its control input, and receiving a reference voltage coupled to its source, and its drain providing the regulated output cache voltage connected to the cache power rail. This embodiment enables effective and efficient on-chip voltage regulation.

Additionally, an embodiment of the present disclosure where the output field effect transistor (FET) comprises an output PFET receiving the gate control signal coupled to its gate, the reference voltage coupled to its source, and its drain providing the regulated output cache voltage connected to the cache power rail. This embodiment enables effective and efficient on-chip voltage regulation.

Additionally, an embodiment of the present disclosure where the shunt current circuit comprises an NFET coupled between the cache power rail and a shunt resistor coupled to ground potential, the NFET receiving the cache activity signal at its gate, and receiving the regulated output cache voltage at its drain and its source coupled to the shunt resistor. This embodiment enables effective and efficient on-chip voltage regulation,

Additionally, an embodiment of the present disclosure where the cache activity turns off the NFET to remove the shunt current from the voltage regulator when the cache is being accessed. This embodiment enables effective and efficient on-chip voltage regulation.

Additionally, an embodiment of the present disclosure further includes resetting the cache activity signal, by the cache controller, following the cache access, and where the cache activity turns on the NFET to provide shunt current from the voltage regulator based on the reset cache activity signal. This embodiment enables effective and efficient on-chip voltage regulation.

Additionally or alternatively, an embodiment in which the shunt current circuit comprises a transistor switch coupled between the cache power rail and a shunt resistor coupled to ground potential, and the transistor switch receives the cache activity signal at its control input to turn off the transistor switch and remove the shunt current from the voltage regulator when the cache is being accessed, has the advantage of reducing power requirements, and minimizing noise and voltage fluctuations of the regulator output.

Additionally or alternatively, an embodiment in which the cache controller produces a cache activity signal, based on the cache being accessed; and the cache controller control a transistor switch of the shunt current circuit to turn off the transistor switch and remove the shunt current from the voltage regulator when the cache is being accessed, and the cache controller control resets the cache activity signal following the cache being accessed, in which the shunt current circuit provides shunt current, has the advantage of reducing power requirements, and minimizing noise and voltage fluctuations of the regulator output.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

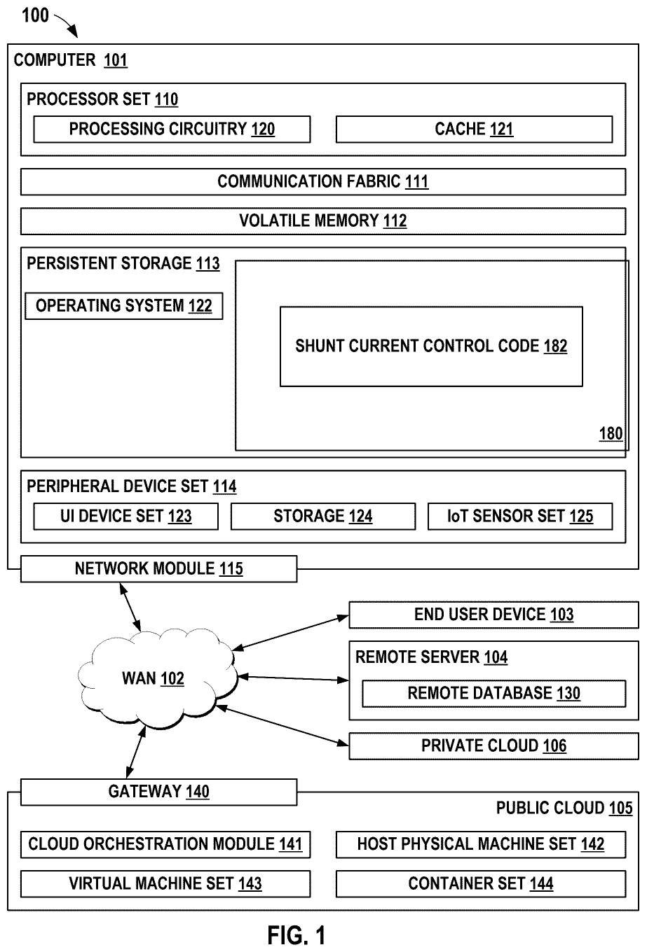

Referring to FIG. 1, a computing environment 100 contains an example of an environment for the execution of at least some of the computer code involved in performing the inventive methods, such as a Shunt Current Control Component 182, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Disclosed embodiments provide a memory storage system comprising a cache, a cache controller, and an on-chip voltage regulator. In an embodiment, the on-chip voltage regulator includes a two-stage on-chip regulator with an output transistor providing a regulated cache output voltage coupled to a shunt current circuit and to the cache via a cache power rail. The shunt current circuit is coupled between the cache power rail and a ground potential, and provides a shunt current for regulator output stability. In an embodiment, the shunt current circuit includes a transistor switch coupled between the cache power rail and a shunt resistor, and the transistor switch is controlled by a cache activity signal to turn off based on based on the cache being accessed. The memory storage system includes a cache controller that produce the cache activity signal when the cache is being accessed and send the cache activity signal to the transistor switch of the shunt current circuit, where the cache activity signal causes the shunt current to be removed from the voltage regulator.

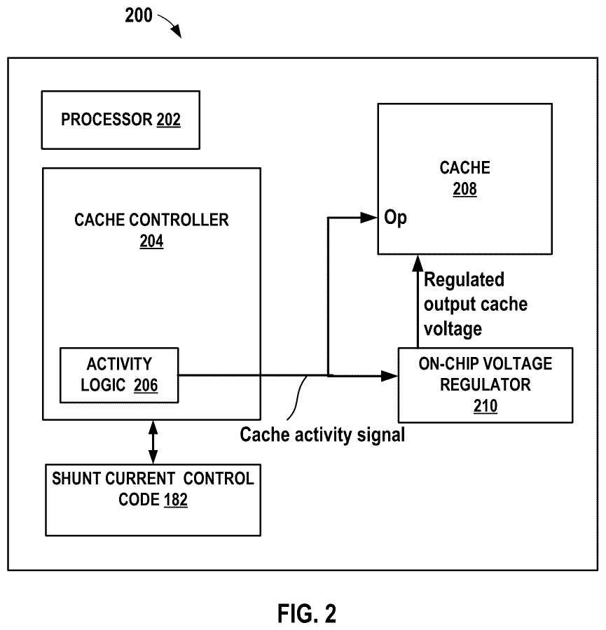

FIG. 2 illustrates an example system 200 for implementing enhanced shunt current control functions of an on-chip voltage regulator of one or more disclosed embodiments. System 200 can be used in conjunction with the computer 101 and cloud environment of the computing environment 100 of FIG. 1 with the Shunt Current Control Code 182 for implementing methods according to one or more embodiments. In a disclosed embodiment, system 200 implements a memory storage system having enhanced on-chip voltage regulation with dynamic load ranges for memory storage in accordance with disclosed embodiments.

System 200 includes one or more processors 202, and a cache controller 204 including activity logic 206 coupling a cache activity signal to a cache 208, and an on-chip voltage regulator 210 of a disclosed embodiment. The cache controller 204 is configured using Shunt Current Control Code 182 of a disclosed embodiment and includes a suitable implementation to perform memory control functions for the cache 208 of system 200. The cache controller 204 including the activity logic 206 produces the cache activity signal based on the cache 208 being accessed, for example for read and write operations. As shown, the on-chip voltage regulator 210 outputs the regulated output cache voltage coupled to the cache 208 via a cache power rail represented by line Regulated output cache voltage.

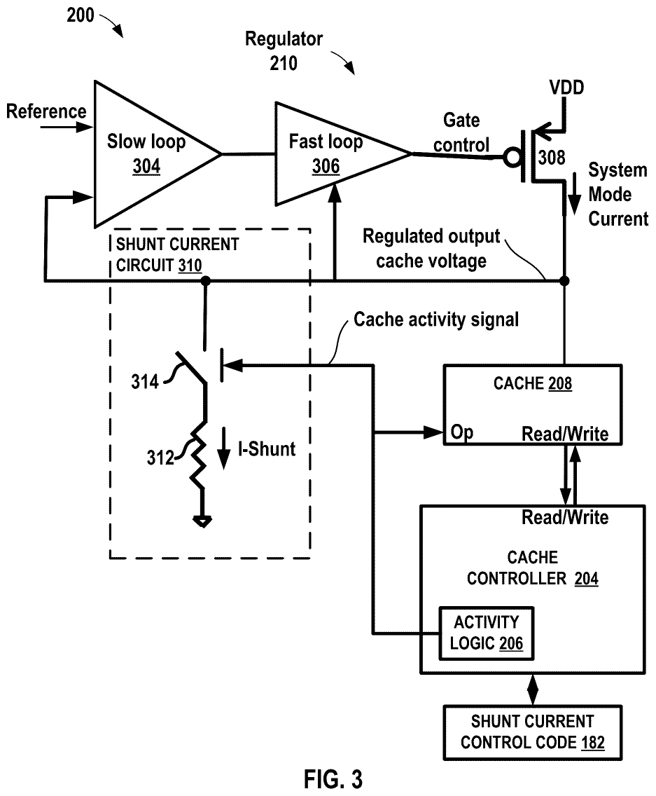

FIG. 3 illustrates example details of an example on-chip voltage regulator 210 of system 200 of one or more embodiments of the present disclosure. In FIGS. 3, 4, and 5, the same reference numbers are used for identical or similar component as used in FIG. 2. As shown, the on-chip voltage regulator 210 is a dual stage regulator including a first stage slow loop 304 coupled to a second stage fast loop 306 that provides a gate control signal to an output transistor 308, and a shunt current circuit 310 configured to provide a shunt current for regulator output stability.

As shown, the slow loop 304 or first regulator stage of the on-chip voltage regulator 210 receives a reference voltage Reference at a first input, and the regulated output cache voltage at a second feedback input. In an embodiment, the reference voltage Reference is received from an external power supply. The fast loop 306 or second regulator stage of the on-chip voltage regulator 210 receives an output of the first stage slow loop 304 and the regulated output cache voltage at a second feedback input. As shown, the output transistor 308 is implemented by a p-type field effect transistor (PFET) that receives the gate control coupled to its gate, (e.g., the output transistor 308 may be implemented with various transistor types, such as a metal-oxide semiconductor field effect transistors (MOSFET), p-channel PFET, or an n-channel NFET). As shown, the PFET 308 has a reference voltage VDD coupled to its source and its drain provides the regulated output cache voltage with system mode current, indicated at line System Mode Current. The output transistor 308 alternatively can be implemented by an n-type field effect transistor (NFET). In an embodiment, the reference voltage VDD may be the same reference voltage Reference that is received from an external power supply or an on-chip reference voltage.

As shown, the shunt current circuit 310 is connected between the regulated output cache voltage and a ground potential and provides a shunt current, I-shunt, to enable regulator output stability. In an embodiment, the shunt current circuit 310 includes a transistor switch 314 connected between the regulated output cache voltage and a shunt resistor 312 coupled to ground potential and having a switch control input of the cache activity signal produced by the cache controller 204 to remove the shunt current, I-shunt based on the cache 208 being accessed. The transistor switch 314 can be implemented by a field effect transistor (FET), such as an NFET 314 having its drain coupled to the cache power rail and its source coupled to the shunt resistor 312, and receives the cache activity signal at its gate. Alternatively, the transistor switch 314 can be implemented by a PFET, having its source coupled to the cache power rail and its drain coupled to the shunt resistor 312.

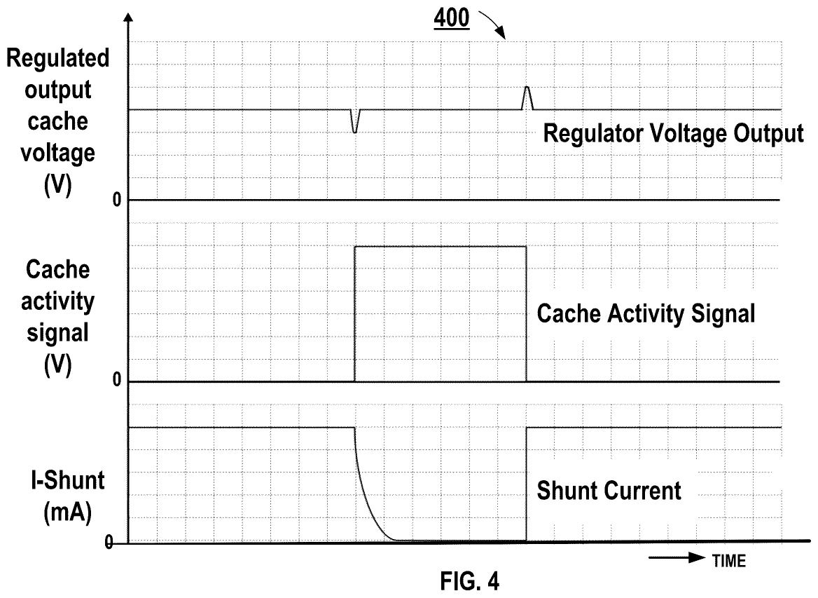

FIG. 4 is a chart providing example illustrative waveforms 400 of the system 200 of one or more disclosed embodiments. In FIG. 4, the waveforms 400 include simulated waveforms Regulated output cache voltage, Cache activity signal, and I-Shunt illustrating voltage and shunt current operations and functions of the on-chip voltage regulator 210 based on the cache activity signal of disclosed embodiments. The waveform Regulated output cache voltage illustrates the regulator voltage output applied to the cache 208 and the shunt current circuit 310, as shown in FIG. 3, which provides a shunt current I-shunt based on a cache activity signal for regulator output stability. As shown, the waveform Regulated output cache voltage of the on-chip voltage regulator 210 includes a substantially constant voltage level with a short duration decrease or minimal undershoot voltage when the Cache activity signal is activated based on the cache 208 being accessed, and a minimal overshoot voltage when the Cache activity signal is reset.

As shown, the waveform Cache activity signal includes an initial zero voltage level that is activated to a high voltage level based on the cache 208 being accessed, and is reset to the zero voltage level following the cache being accessed. As shown, the waveform I-shunt includes an initial current flow for regulator output stability that is removed from the voltage regulator 210 when the cache 208 is accessed, and returns to the initial I-shunt current flow based on the Cache activity signal being reset to the zero voltage level following the cache being accessed.

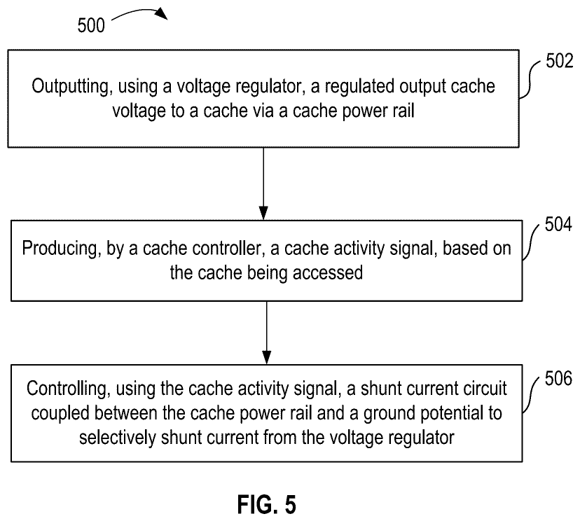

FIG. 5 illustrates example features and operations of a method 500 for implementing shunt current control functions of an on-chip voltage regulator, according to one disclosed embodiment. At block 502, an on-chip voltage regulator outputs a regulated output cache voltage coupled to cache via a cache power rail. In an embodiment, the on-chip voltage regulator 210 comprises a two-stage on-chip regulator having a first regulator stage 304 configured to receive a reference voltage at a first input, and the regulated output cache voltage at a second feedback input, and provide its output coupled to a second regulator stage 306, the second regulator stage configured to receive the regulated output cache voltage and provide a gate control signal at its output coupled to an output transistor 308. In an embodiment, the output transistor 308 comprises an output p-type field effect transistor (PFET) configured to receive the gate control coupled to its gate, receive a reference voltage at its source and output the regulated output cache voltage at its drain connected to the cache power rail.

At block 504, a cache controller produces a cache activity signal, based on the cache being accessed. In an embodiment, the cache controller 204 comprises activity logic 206 providing the cache activity signal, for example based on cache accesses for read and write operations. At block 506, a shunt current circuit coupled between the cache power rail and a ground potential is controlled by the cache activity signal to selectively shunt current from the voltage regulator. In an embodiment, the shunt current circuit comprises a transistor switch 314 coupled between the cache power rail and a shunt resistor coupled to ground potential, and the transistor switch receives the cache activity signal at its control input to turn off the transistor switch 314 and remove the shunt current from the voltage regulator when the cache is being accessed. In an embodiment, the transistor switch 314 comprises an NFET switch 314 coupled between the cache power rail and the shunt resistor 312 coupled to ground potential, where the NFET switch 314 receives the cache activity signal at its gate. The cache activity turns off the NFET switch 314 to remove the shunt current from the voltage regulator 210 when the cache is being accessed. The cache activity signal is reset, by the cache controller 204, following the cache being accessed, and the shunt current circuit 310 provides shunt current from the voltage regulator 210 when the cache activity signal is reset.

While the foregoing is directed to embodiments of the present invention, other and further embodiments of the invention may be devised without departing from the basic scope thereof, and the scope thereof is determined by the claims that follow.

What is claimed is:

1. A method comprising:
outputting, using a voltage regulator, a regulated output cache voltage to a cache via a cache power rail;
producing, by a cache controller, a cache activity signal, based on the cache being accessed; and
controlling, using the cache activity signal, a shunt current circuit coupled between the cache power rail and a ground potential to selectively shunt current from the voltage regulator.

2. The method of claim 1, wherein the shunt current circuit comprises a transistor switch coupled between the cache power rail and a shunt resistor coupled to ground potential, and wherein the transistor switch receives the cache activity signal at its control input to turn off the transistor switch and remove the shunt current from the voltage regulator when the cache is being accessed.

3. The method of claim 1, further comprises resetting the cache activity signal, by the cache controller, following the cache being accessed, wherein the shunt current circuit provides shunt current from the voltage regulator based on resetting the cache activity signal.

4. The method of claim 1, wherein the voltage regulator further comprises a two-stage on-chip regulator having a first regulator stage receiving a reference voltage at a first input, and the regulated output cache voltage at a second feedback input, and providing its output coupled to a second regulator stage, the second regulator stage receiving the regulated output cache voltage and providing a gate control signal at its output.

5. The method of claim 4, wherein the two-stage on-chip regulator comprises an output transistor receiving the gate control signal coupled to its control input, and receiving a reference voltage coupled to its source, and its drain providing the regulated output cache voltage connected to the cache power rail.

6. The method of claim 5, wherein the output transistor comprises an output p-type field effect transistor (PFET) receiving the gate control signal coupled to its gate, the reference voltage coupled to its source, and its drain providing the regulated output cache voltage connected to the cache power rail.

7. The method of claim 6, wherein the shunt current circuit comprises an NFET coupled between the cache power rail and a shunt resistor coupled to ground potential, the NFET receiving the cache activity signal at its gate, and receiving the regulated output cache voltage at its drain and its source coupled to the shunt resistor.

8. The method of claim 7, wherein the cache activity turns off the NFET to remove the shunt current from the voltage regulator when the cache is being accessed.

9. The method of claim 7, further comprises resetting the cache activity signal, by the cache controller, following the cache being accessed, and wherein the cache activity turns on the NFET to provide shunt current from the voltage regulator based on the reset cache activity signal.

10. A system, comprising:
a cache;
a cache controller configured to provide a cache activity signal when the cache is accessed; and
a voltage regulator, the voltage regulator configured to output a regulated cache output voltage to the cache via a cache power rail, and the voltage regulator comprises a shunt current circuit coupled between the cache power rail and a ground potential, and configured to selectively provide a shunt current based on the cache activity signal.

11. The system of claim 10, wherein the shunt current circuit comprises a transistor switch coupled between the cache power rail and a shunt resistor coupled to ground potential, and wherein the transistor switch is configured to receive the cache activity signal at its control input.

12. The system of claim 11, wherein the transistor switch comprises a field effect transistor (FET) configured to receive the cache activity signal coupled to its gate, and wherein the cache activity turns off the FET to remove the shunt current from the voltage regulator when the cache is being accessed.

13. The system of claim 10, wherein the voltage regulator comprises a two-stage on-chip regulator having a first regulator stage configured to receive a reference voltage at a first input, and the regulated output cache voltage at a second feedback input, and provide its output coupled to a second regulator stage, the second regulator stage configured to receive the regulated output cache voltage and provide a gate control signal at its output.

14. The system of claim 13, wherein the two-stage on-chip regulator comprises an output field effect transistor (FET) configured to receive the gate control signal coupled to its gate, a reference voltage coupled to its source, and its drain providing the regulated output cache voltage connected to the cache power rail.

15. The system of claim 14, wherein the output field effect transistor (FET) comprises an output PFET, and wherein the shunt current circuit comprises an NFET coupled between the cache power rail and a shunt resistor coupled to ground potential, the NFET configured to receive the cache activity signal at its gate.

16. An on-chip voltage regulator comprising:
a cache power rail configured to output a regulated cache output voltage to a cache,
a shunt current circuit configured to receive the cache output voltage and provide a shunt current; wherein the shunt current circuit comprises a switch coupled between the cache power rail and a shunt resistor coupled to ground; and wherein the switch is configured to receive a control input of a cache activity signal that represents the cache being accessed, wherein the cache activity signal turns off the switch to remove the shunt current from the on-chip voltage regulator when the cache is being accessed.

17. The on-chip voltage regulator of claim 16, further comprises a cache controller having activity logic configured to produce the cache activity signal, based on the cache being accessed, and to send the cache activity signal to a control input of the switch.

18. The on-chip voltage regulator of claim 16, wherein the switch comprises a field effect transistor (FET) configured to receive the cache activity signal coupled to its gate, and its source and drain coupled between the cache power rail and the shunt resistor.

19. The on-chip voltage regulator of claim 16, wherein the on-chip voltage regulator comprises a two-stage on-chip regulator having a first regulator stage configured to receive a reference voltage at a first input, and the regulated output cache voltage at a second feedback input, and provide its output coupled to a second regulator stage, the second regulator stage configured to receive the regulated output cache voltage and provide a gate control signal at its output.

20. The on-chip voltage regulator of claim 19, wherein the two-stage on-chip regulator comprises an output field effect transistor (FET) configured to receive the gate control signal coupled to its gate, a reference voltage coupled to its source, and its drain providing the regulated output cache voltage connected to the cache power rail.
